(19) United States
(12) Patent Application Publication
(10) Pub. No.: US 2026/0355637 A1
(43) Pub. Date: Nov. 12, 2026

(54) COMPUTING PLATFORM ARCHITECTURE FOR PROVIDING AN ONLINE GAMING SYSTEM WITH A DIGITAL ECONOMY

(71) Applicants: Denis Dyack; Yuriy Toporovskyy; Paul Rogozinski

(72) Inventors: Denis Dyack; Yuriy Toporovskyy; Paul Rogozinski

(21) Appl. No.: 19/126,324

(22) PCT Filed: Nov. 14, 2023
(86) PCT No.: PCT/IB2023/061503

§ 371 Date: May 1, 2025

Related U.S. Application Data
(60) Provisional application No. 63/426,511, filed on Nov. 18, 2022.

(51) Int. Cl. A63F 13/79; A63F 13/355; G06F 16/27; H04L 67/131

(52) U.S. Cl. CPC A63F 13/79; A63F 13/355; G06F 16/27; H04L 67/131

(57) ABSTRACT

A computing architecture for managing ownership of in game assets using blockchain. The architecture combines standard distributed databases, server replicas, eventual consistency, partial ordering of events in distributed systems with the replication of data between blockchain and cloud servers. The architecture allows for robust control of ownership of in game assets without sacrificing game play and game responsiveness.

### CROSS-REFERENCE TO RELATED APPLICATIONS

This invention claims priority to U.S. Provisional Application No. 63/426,511 filed on Nov. 18, 2022.

### BACKGROUND OF THE INVENTION

### 1. Field of the Invention

The present invention relates to online gaming systems and, more particularly, to an architecture that provides blockchain based tracking of gaming assets.

### 2. Description of the Related Art

Online games frequently provide players with the ability to acquire, possess, and trade in game or digital assets associated with game play. For example, players can acquire in game items representing tangible assets such as weapons, equipment, food and the like and also can acquire digital assets such as status changes based on the amount of playing time or success in achieving milestones. Tracking ownership of these assets can be complex and does not actually offer players with true ownership of any assets or a way to guarantee authoritative management of ownership. Conventional approaches, including those that take advantage of blockchain, do not confirm ownership changes rapidly enough for seamless game play. As a result, there is a need in the art for a platform that can provide for robust tracking of ownership of assets associated with a game in manner that allows players to possess true ownership of assets without compromising game play.

### BRIEF SUMMARY OF THE INVENTION

The present invention is a computing platform architecture that can provide blockchain tracked ownership of digital game assets using high availability and low latency centralized databases. The inclusion of blockchain provides for persistence and true ownership of digital items. The architecture is agnostic with respect to specific game content or style of play, and thus can support various types of games and implement the arbitrary business logic specific to the game and whatever economic rules the game developer wishes to provide. The architecture is transparent and does not require that game players understand the architecture. Game providers are not dependent on any specific system and can interact with the blockchain components directly without needed to contact a cloud endpoint.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of the architecture for a computing platform according to the present invention.

FIG. 2 is a schematic of the architecture for a reconciliation approach for a computing platform according to the present invention.

FIG. 3 is a schematic of the ownership of in-game assets.

### DETAILED DESCRIPTION OF THE INVENTION

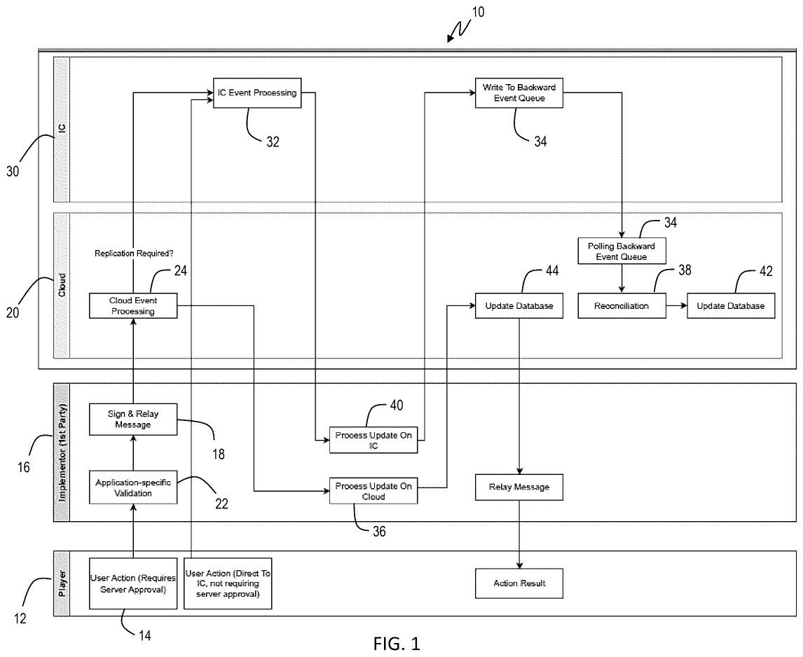

Referring to the drawings, wherein like numeral refer to like parts throughout, there is seen in FIG. 1 an architecture for a computing platform 10 that provides a digital economy for players 12 where user actions 14 taken by players when engaged in gaming impact ownership of in game assets of the particular game supported by platform 10. Platform 10 is an architecture, not a gaming application, that allows a game implementor (referred to as the “first party”) to add their own functionality (“business logic”) in predefined places in the architecture of computing platform 10 to interact with the actual gaming application so that platform 10 can provide the desired functionality. As an example, platform 10 may be implemented as a hybrid web2/web3 architecture running on blockchain, as an example, the Internet Computer (IC) and the cloud (AWS for example) to establish a digital economy on the IC, which has the advantages of both web2 and web3, i.e., a high availability & low latency of centralized databases, a user experience is comparable to a traditional centralized database, hiding latency of time-to-finality persistence and ownership of blockchain, and that end users can have true ownership of their digital items. The architecture of platform 10 provides as much configurability as possible, with gaming applications able to be built on top of platform 10 with platform 10 implementing arbitrary business logic specific to the desired economy of the gaming application. Platform 10 also provides for transparency where downstream consumers of do not need any particular knowledge of the architecture to operate a gaming application that resides on platform 10. Platform 10 also offers no dependency, where other applications (3rd party or 1st party) can interact with the blockchain directly without ever contacting a cloud endpoint as such applications would then lose the UX of a cloud database. Platform 10 also offers generality where 1st party applications can run arbitrary code in both cloud services and on the IC and cost & robustness where 1st party applications can implement functionality and store data in one or both of the cloud database and the IC, as appropriate.

Platform 10 places some requirements on which features the business logic must provide, but these requirements are not meant restrict what the business logic can do. Rather, these requirements describe a superset of functionality which the implementor may in fact provide in a large variety of different ways, for example, a cloud server vs. a physical on-premises server, or a SQL database vs. a NoSQL database vs. some more complicated distributed database, collectively represented as database 42 and database 44. The implementor should provide to the architecture: (i) capabilities for record data associated by unique IDs, e.g. as implemented by SQL or NoSQL database engines (i. e database primary keys), where the unique IDs are opaque but have fixed size; (ii) serialization of scalar types (e.g. integers, floats, strings), and compound types (e.g.) in a consistent manner for inter-machine interoperability, for example, JSON or CBOR storage of custom framework-level metadata associated with record IDs (timestamps); (iii) tag-based message categorization (i.e. a transparent, stateless function from each message to a single scalar value, which might be a string or integer, which indicates the logical “type” of the message) which is used for skipping some types of operations based on a messages tag (e. g. for JSON messages this may be a projection from a JSON object to the key “msg_type”). An example of an approach which satisfies these constraints is a mongoDB server with an object type schema containing a “message type” property and a “timestamp” property for every record.

Resolving conflicting updates between the blockchain and the centralized server is the core element of platform 10 and drives much of our design. Abstractly, the blockchain server, such as the Internet Computer (IC), and centralized distributed database replicas which both can operate independently and achieve eventual consistency. Conflict resolution is a process which applies to sequences of events, which crucially may be observed in different orders on different replicas. Generally, resolution is different these following cases: any ordering of events is valid, only some orderings of events are valid, and no ordering of events is valid. Platform 10 allows for resolution of conflicts caused by out-of-order operations for some types of data whose semantics are well understood (e.g. counters, append only lists). These datatypes are similar to CRDTs, except with the additional property that the blockchain is authoritative, so platform 10 can fail to resolve a conflict and just fall back to the authoritative state, which are referred to partial CRDTs.

In particular, where general CRDTs are described (in part) by a function called “update” which maps the current value of the datum and an update message to a new value (with the constraint that message re-ordering gives the same eventual result), the “update” function for partial CRDTs is partial, that is, it may fail. General CRDTs work well at modelling the application semantics when (roughly) “every user can do anything”. In fact, there are very limited cases where that is true; intended applications assign strict semantics to all update operations. CRDTs provide a user-friendly way to handle the “fast path” and by relaxing the strict requirement that every operation on a CRDT be conflict-free, it is possible to represent a larger subset of operations in a conflict-free manner. This handles case 1 above and also handles case 2 if a valid ordering is observed.

To motivate this approach to conflict resolution, the behavior of platform 10 if conflict resolution were skipped altogether is not possible, that is, to always simply replace the cloud database row with the blockchain datum. This would mean rolling back user operations more frequently, or in other words, requiring that any two simultaneous operations always be serialized. This degrades the user experience because it exposes transient states which they likely do not care about. If the user is initiating simultaneous operations (or perhaps, via some delegation, the multiple entities can act simultaneously to perform actions on the same users' data) then they should expect to see either Start, A, B or Start, B, A but they should not expect to see one final result or the other. On the other hand, if these operations have only one order which makes sense (for example, if A is “enchant an item” and B is “trade the item to someone else”) any other ordering should be rejected.

When multi-party asynchronous transactions are considered, it may be desired to reject some events altogether (i.e. refuse to perform them on the blockchain) in cases where there is no serialized order which makes sense. For example, in event A, user X modifies an item Q, and in event B, user X trades Q to Y, and in event C, Y approves the trade with the view of the item state before A. Here the cloud db might see “BA”, and so rejects A because X is no longer the items' owner. But the blockchain might see AB, and reject B because the approval timestamp is stale. Once the centralized server receives the update message from the blockchain, it must “un-do” (rollback) B and “re-do” A on the cloud db. This handles case 3 above and also handles case 2 if we did not observe a valid ordering.

Note that the architecture of platform 10 would allow Y to re-approve a new trade immediately, but for all practical purposes presenting this option is a bad idea because it would appear to Y as a sort of “bait and switch” scam. The correct UX is to present this case to Y as “transaction failed because Q no longer exists.” However, no technical requirements are placed on when an asynchronous transaction must fail (the failure modes are configurable by the first party implementor). An invalid transaction approval (for example, malformed message, or state approval timestamp) may or may not cause a transaction to fail. A fixed or configurable timeout may or may not cause a transaction to fail. Finally, it should be noted that without at least one mechanism for failing transactions, the set of pending transactions grows without bounds and quickly consumes all memory available on the system.

One potential formalism is given to describe the concepts of “sees before” or “sees after” described above. Vector clocks are used on the replicas to create a partial ordering of events. Events are object updates, i.e., update calls on the IC or database updates on the centralized server. Event partial ordering allows us to validate a consistent view of data during asynchronous transactions.

More specifically, a player 12 may be engaged in game action 14 via a browser that communicates with a game server 16 that is configured to sign and relay messages 18 based on events that occur in game action 14 to a cloud processor 20. The forward event queue commences with game server 16 checking events issued from player 12 for some in game properties in the conventional manner (e.g., using client-server prediction may result in a “hit” on the client and a “miss” on the server). Valid events are signed with an admin identity 22. Events are relayed to cloud processor 20, such as AWS Lambda. Receipt of messages with valid signatures increments a “C” vector clock. Cloud processor 20 decides, using a cloud event processing task 24, based on the type of event (sync/async), whether to process immediately or push to a cloud event queue 36 for processing. This functionality should be accessible by both Cloud Processor 20 and the IC processor 30 and thus is also represented in FIG. 1 by a Process Update on IC 40. Cloud processor 18 determines whether to replicate the event to a blockchain server such as the Internet Computer (IC) 30 capable of tracking ownership of assets using blockchain, such as when the particular event impacts ownership of in game assets. Thus, any in-game actions 14 of player 12 that trigger ownership changes of in-game assets can be passed directly to IC 30 for tracking of ownership changes using blockchain.

For cloud event processing 24, events issued from player 12 are validated in an application-specific manner (e.g. in an online multiplayer game, using client-server prediction may result in a “hit” on the client and a “miss” on the server; the client may have sent a “hit” type event but the server decides that this event is invalid). The event's IC signature is verified (that is, it is expected that this event data has been constructed in a manner compatible with the blockchain ingress message format, including any headers or signatures required for the blockchain to verify the message). Optionally, the event is replicated to the IC 30. Valid events are signed with the admin identity. That is, this event is pre-approved by the admin identity. Events are relayed to the application cloud processor (e.g. AWS Lambda). Receipt of the message with valid signatures increments the “C” vector clock. The application-specific event handling determines if this is a synchronous event (e.g. an HTTP GET request whose result data is expected in the HTTP response), and if so, waits for the application-specific event processing to occur, and relays the result.

IC event processing 32 begins upon receipt by IC 20 of replicated messages from cloud event processing 24, where transactional events must wait if any element of their “conflicting write set” is still being updated. The events are placed in a queue and later processed via heartbeat. Any potentially conflicting write set for the transaction is retrieved, and the keys are locked in a transaction table. A read set is retrieved and then IC 30 awaits the corresponding canisters for each read datum. Any updates, i.e., the business logic, may then be applied. Object data is written in each corresponding canister. Conflicting write set keys may be unlocked and the deltas computed for old versus new.

A backward event queue 34 is established by IC 30 by publishing a list of updated primary keys (i.e. “object IDs”) along with the update or the data that was changed (“deltas”) 50 and 52, ordered by transaction completion time by inserting into a queue 54. The list is ordered by topological sort on casual structure. The list is readable by cloud processor 20 via query calls (fast polling) 56 and asynchronously written by transaction implementations (after completing a transaction). This list is implemented as a bounded queue to minimize messaging overhead. After an IC transaction implementation has completed writing to the ordered transaction list, it updates the vector clock B 58 to the later value of: the previous value of the vector clock B, and the latest timestamp of any element which it wrote. This indicates that elements in the queue up to timestamp B are ready for reading.

Cloud processor 20 polls the updated objects list (since the last seen “B” vector clock) and the updated data for each object and puts it into a queue 64 for process update 36, such as AWS SQS. Each poll updates the last seen “B” vector clock 60 by the poller service (note: differs from the vector clock of the database). Every K poll updates 62 (or every T seconds, or some other metric), use a single update call to clear messages from the IC queue up to the last seen timestamp. This action ensures each such update record is only ever read once. This data is pulled from the IC queue into SQS as fast as possible to keep the queue size small.

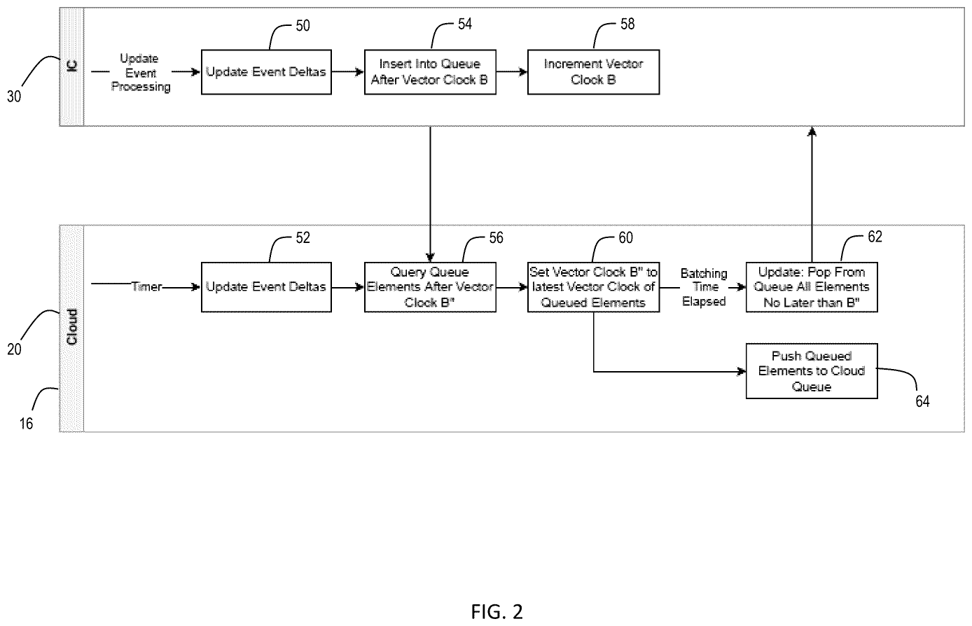

Referring to FIG. 2, reconciliation is performed by reading from a backward event queue 34, such as SOS, where a number of messages that are split into groups based on object ID (table primary keys). Based on event action type (e.g. “buy_item”, “open_chest”, “slain_enemy”), cloud processor 20 determines whether the transaction has been implemented by cloud processor 20, the blockchain of IC 30, or both to provide for reconciliation 38. Conflicts arise when an action is implemented in both, and gives a different result than that computed by cloud processor 20. Action types which are implemented only by blockchain or only by cloud trivially conflict free. Otherwise, if the timestamp of the update message is ordered “after” the timestamp of the object, the update is not conflicting. The cloud database record is updated to the latest value by applying the delta directly to the old value. Otherwise, if the timestamp of the update message is unordered with respect to the timestamp of the object. If each of the updated columns have potentially non-conflicting types, and each can be resolved for the last seen value, the resolved value is applied. Otherwise, the data canister is queried for the latest value of the row. After reconciliation, the timestamp of the row is updated to the latest IC timestamp (which is the timestamp returned from data canister query if rollback was performed, otherwise timestamp in the update message). Following are examples of some execution sequences that may occur in which commands come from different replicas and require eventual reconciliation. In the example of multiple purchases, User A initiates a purchase of item X for 10 coins, Y for 10 coins, but only possesses 15 coins. In another example of a double sell, User A sells items X to B and simultaneously sells item X to C. In a further example of a fake insufficient balance, User A with balance of 1 coin receives 10 coins, and simultaneously initiates a purchase of X for 5 coins. In an additional example of missing events, User A initiates transactions X, Y which are relayed to IC as X′, Y′, but delivered as Y′, X′ (or Y′, _ or X′, _).

Potentially conflict-free datatypes are handled by an approach that allows resolution of resolve out-of-order operations for some types of data whose semantics are well understood, such as counters and append only lists. This is basically CRDTs but with the additional property that the blockchain is authoritative so it is possible to fail to resolve a conflict and just fall back to the authoritative state. General CRDTs work well at modelling the application semantics when (roughly) “every user can do anything”. In fact, there are very limited cases where that is true; the intended applications assign strict semantics to all update operations. CRDTs provide a user-friendly way to handle the “fast path”.

It should be recognized that it is possible to skip conflict resolution altogether by replacing the cloud database row with the blockchain datum, but that would mean rolling back user operations more frequently, in other words, requiring that any two simultaneous operations always be serialized. This degrades the user experience since it exposes transient states which users do not typically care about. If the user is initiating simultaneous operations (or perhaps, via some delegation, the multiple entities can act simultaneously to perform actions on the same users' data) then they should expect to see either Start, A, B or Start, B, A but they shouldn't expect to see one or the other. On the other hand, if these operations have only one order which makes sense (for example, if A is “enchant an item” and B is “trade the item to someone else”) any other ordering should be rejected.

With respect to multi-party approval asynchronous transactions, the rejection of some actions altogether may be warranted in cases where there is no serialized order that makes sense, i.e., platform 10 refused to perform them on the blockchain. For example, A=X enchants an item Q, B=X trades Q to Y, and Y approves the trade with the view of the item state before A; cloud processor 18 sees BA (and rejects A because X is no longer the item owner); blockchain sees AB (and rejects B because the approval timestamp is stale). Here, platform 10 must rollback or undo B, to reperform or redo A on the cloud db. The architecture of platform 10 will thus allow Y to re-approve a new trade immediately, but for all practical purposes presenting such an option is not preferred because it has the appearance of a “bait and switch” scam. The UX should present this case as “failed because Q no longer exists”. In this case, cloud processor 18 will see a single update event, such as “{Q.fire_damage +=10} @ T0.”

Platform 10 also provides for a shared global state, where some records in the database are not stored per user but instead are shared amongst the world. For example, treasure chests may cycle through different classes of items (some items rotate in and out of availability). These updates are infrequent, so system 10 treats them as a global synchronization point, during which events wait in the cloud event queue until the cloud database has received the timestamp of the global synchronization event from the blockchain.

Platform 10 may also be used to support the transition of ownership of the intellectual property of a gaming application including any or all game content. Players can earn or acquire blockchain registered ownership rights in any portion or all of the game content any point in time, including dynamic content or content submitted by players through world building that is rewarded by ownership in the submitted content or a percentage of the overall content. System 10 thus provides for an ownership launch comparable to an initial public offering, albeit for ownership of the intellectual property in the game itself, referred to as an intellectual property initial public offering (IIPPO). Ownership shared can be based on existing coin models and launched contemporaneously with the game itself or any point in time thereafter. Ownership could alternatively or additionally be controlled via tokens. In either case, ownership units can be acquired during game player, such as by awards for time spend playing, earned through game play, or acquired via more conventional means. To protect the intellectual property right and ensure that a game controlled, at least in part, through player ownership, platform 10 can facilitate control through decentralized mechanisms, such as decentralized autonomous organizations (DAOs), that provide a legal structure that has no central governing body and whose members share a common goal to act in the best interest of the entity. In this way, even if the game developer elects to no longer support a particular game, platform 10 can allow existing player owners to continue the legacy and ensure that a popular game maintains available.

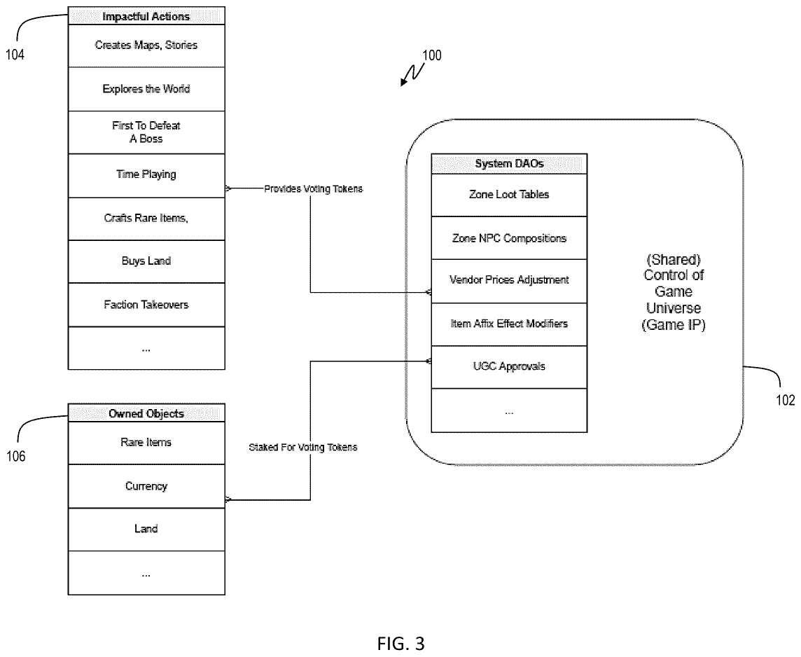

Referring to FIG. 3, platform 10 can allow ownership of intellectual property of the game itself 102 and thus combine aspects of an IPO, where the IP is coined as an HIPPO. Also, in the case of a coin launch, an ICO and IP may be known as an IIPCO. At first IP, owners may control 100 percent of the IP, but as gamers play the game and take impactful actions 104 or acquire owned objects 106, they will be granted a percentage of the intellectual property of the game itself 102 and given voting rights (shares) IIPPO or coins (IIPCO), with the governance of the IP being controlled through Decentralized Autonomous Networks (DAOs).

An additional benefit of platform 10 is that it allows for the creation of Non-Fungible-Objects (NFOs), rather than convention non-fungible tokens (NFTs) that are merely ownership receipts. Platform 10 can bundle the ownership chain with the content of the owned item itself so that the NFO contains the content itself in addition to the ownership registration. In this manner, the NFO itself has intrinsic value for the user and thus provides true secure ownership of items. In game collectible items having complex properties and mechanics that could otherwise be lost even if registered using blockchain if, for example, the developer shuts down the game, may now be truly owned by players as the properties and mechanics are also recorded on the blockchain. Platform 10 thus allows for storing complicated data describing the properties of objects, which have actions and can mutate in a structured manner. Platform 10 provides a predicate language for expression permissions on objects, allowing for both machine verification of the validity of transactions and human interpretation of the value proposition of an action.

What is claimed is:

1. A computing architecture for a game, comprising:
a player interface for receiving a plurality of in-game action requests from a player using a gaming system;
a game server in communication with the player interface for receiving the plurality of in-game action requests and configured to relay a plurality of messages corresponding to the plurality of in-game action requests;
a cloud processor configured to receive the plurality of messages corresponding to the plurality of an in-game action requests and determined which, if any, of the plurality of messages should be replicated; and
a blockchain server configured to receive any of the plurality of the messages that are replicated and to update a record reflecting ownership of an asset using blockchain based on any of the plurality of the messages.

2. The computing architecture of claim 1, wherein the game server is programmed to relay the plurality of messages corresponding to the plurality of in-game action requests if each of the plurality of messages includes a valid signature.

3. The computing architecture of claim 2, wherein the cloud processor is programmed to determine which, if any, of the plurality of messages should be replicated based on whether each of the plurality of messages represent an event that impacts ownership of an in-game asset.

4. The computing architecture of claim 3, wherein the blockchain server is programmed to place the plurality of messages in the queue into a backward event queue.

5. The computer architecture of claim 4, wherein the blockchain server is programmed to split the plurality of messages in the backward event queue into groups based on an object identification associated with each of the plurality of messages.

6. The computer architecture of claim 5, wherein the blockchain server is programmed to resolve any conflicts presented by the plurality of messages in the backward event queue.

7. The computer architecture of claim 1, wherein the asset is an in-game object.

8. The computer architecture of claim 1, wherein the asset in an ownership share of an intangible asset.

9. A method of providing a digital economy in an online game, comprising:
receiving a plurality of in-game action requests from a player using a gaming system with a player interface;
receiving the plurality of in-game action requests with a game server in communication with the player interface and relaying a plurality of messages corresponding to the plurality of in-game action requests;
receiving the plurality of messages corresponding to the plurality of in-game action requests with a cloud processor and determining which, if any, of the plurality of messages should be replicated; and
replicating any of the plurality of the messages that should be replicated to a blockchain server to update a record reflecting ownership of an asset using blockchain based on the plurality of the messages that are replicated.

10. The method of claim 9, wherein the game server will relay the plurality of messages corresponding to the plurality of in-game action requests if each of the plurality of messages includes a valid signature.

11. The method of claim 10, wherein the cloud processor determines which, if any, of the plurality of messages should be replicated based on whether each of the plurality of messages represents an event that impacts ownership of an in-game asset.

12. The method of claim 11, wherein the blockchain server places the plurality of messages in the queue into a backward event queue.

13. The method of claim 12, wherein the blockchain server splits the plurality of messages in the backward event queue into groups based on an object identification associated with each of the plurality of messages.

14. The method of claim 13, wherein the blockchain server resolves any conflicts presented by the plurality of messages in the backward event queue.

15. The computer architecture of claim 1, wherein the asset is an in-game object.

16. The computer architecture of claim 1, wherein the asset in an ownership share of an intangible asset.
